(19) United States
(12) Patent Application Publication
(10) Pub. No.: US 2009/0255489 A1
(43) Pub. Date: Oct. 15, 2009

(54) Straddle Type Vehicle

(75) Inventors: Hideki FUJIWARA, Shizuoka (JP); Eigo KITAMURA, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 12/420,694

(22) Filed: Apr. 8, 2009

(30) Foreign Application Priority Data
Apr. 14, 2008 (JP) 2008-104248

(51) Int. Cl. F01P 9/04; B62K 11/00

(52) U.S. Cl. 123/41.57; 180/229

(57) ABSTRACT

A motorcycle includes an engine, a radiator that cools a cooling liquid, a first piping that connects the engine to the radiator, and a second piping that connects the engine to the radiator. The second piping, engine, radiator and first piping form a circulating circuit through which cooling liquid circulates. At least one of the first and second pipings is substantially constituted by resin piping. The time required to warm up the engine is thereby reduced.

### RELATED APPLICATIONS

This application claims the benefit of priority under 35 USC 119 of Japanese patent application no. 2008-104248, filed on Apr. 14, 2008, which is hereby incorporated by reference.

### BACKGROUND OF THE INVENTION

1. Field of the Invention

The present invention relates to a straddle-type vehicle, and particularly relates to a straddle-type vehicle including a radiator.

2. Description of Related Art

A motorcycle including a water-cooled engine as disclosed, for example, in Japanese Patent Application Laid-Open No. 2007-77908, conventionally includes a radiator for cooling a cooling liquid for cooling the engine. Iron piping is typically used to connect the engine to the radiator.

Meanwhile, to comply with emission controls that tend to be stricter, demand for quickly warming up the engine has recently risen. In a state in which the engine temperature is low, the activity of a catalyst that purifies the exhaust gas is low and it is therefore difficult to attain a sufficient exhaust gas purification function.

However, if iron piping is used to connect the engine to the radiator, it is difficult to quickly warm up the engine because metal such as iron is high in heat conductivity, and heat of the cooling liquid warmed by the engine is apt to be radiated through the iron piping.

### SUMMARY OF THE INVENTION

The present invention addresses these issues and reduces the time required to warm up an engine in a vehicle including a radiator.

A straddle-type vehicle according to the present invention includes an engine, a radiator that cools a cooling liquid, a first piping that connects the engine to the radiator, and a second piping that connects the engine to the radiator. The second piping, the engine, the radiator and the first piping form a circulating circuit through which the cooling liquid circulates. At least one of the first piping and the second piping is substantially constituted by resin piping.

According to the present invention, the time required to warm up an engine in a vehicle including a radiator is reduced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a left side view of a motorcycle according to a first embodiment of the invention.

FIG. 2 is a left side view of an engine according to the first embodiment.

FIG. 3 is a plan view of the engine.

FIG. 4 is a schematic plan view of a radiator, a first piping and a second piping according to the first embodiment.

FIG. 5 is a schematic view of the second piping as viewed from direction V of FIG. 4.

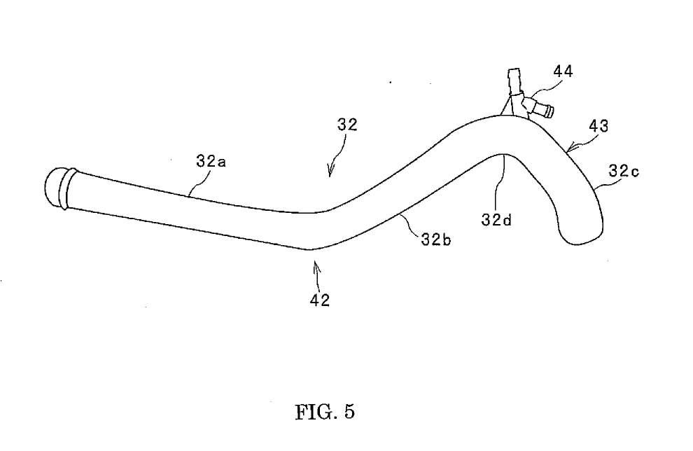

FIG. 6 is a circuit diagram for cooling water according to the first embodiment.

FIG. 7 is a schematic partial cross-sectional view for explaining an RFM formation method according to the first embodiment.

FIG. 8 is a schematic partial cross-sectional view for explaining the RFM formation method.

FIG. 9 is a left side view of a scooter according to a second embodiment of the invention.

FIG. 10 is a right side view of an engine and a radiator according to the second embodiment.

FIG. 11 is a plan view of the engine and the radiator according to the second embodiment.

### DETAILED DESCRIPTION OF THE INVENTION

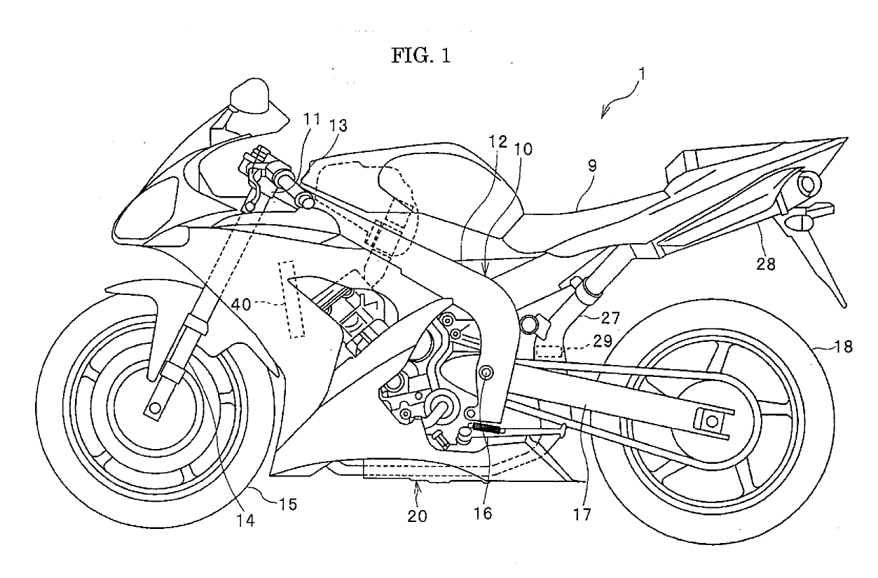

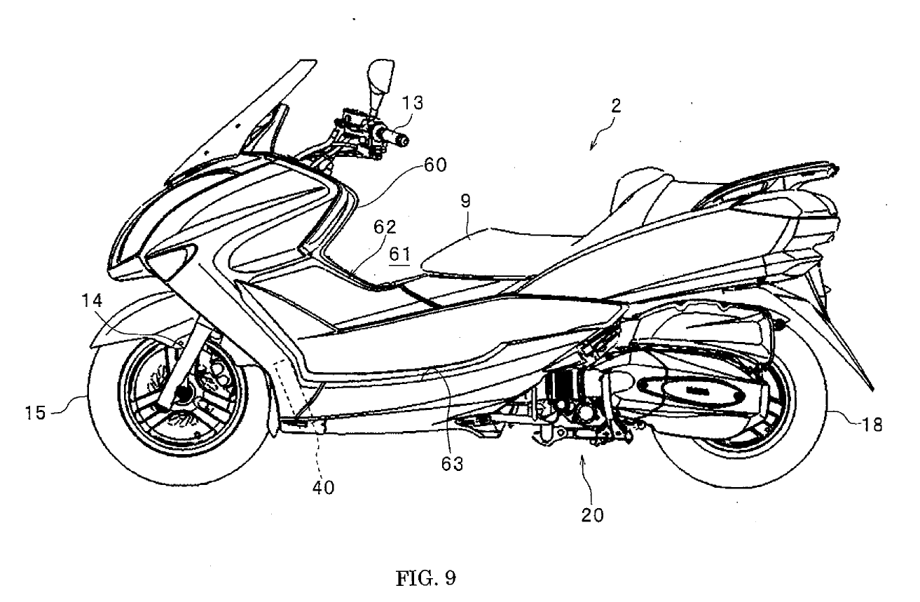

Embodiments of the present invention are described in detail with reference to straddle-type vehicles as shown in FIGS. 1 and 9 as an example. These embodiments are given for illustrative purposes only and the present invention is not so limited.

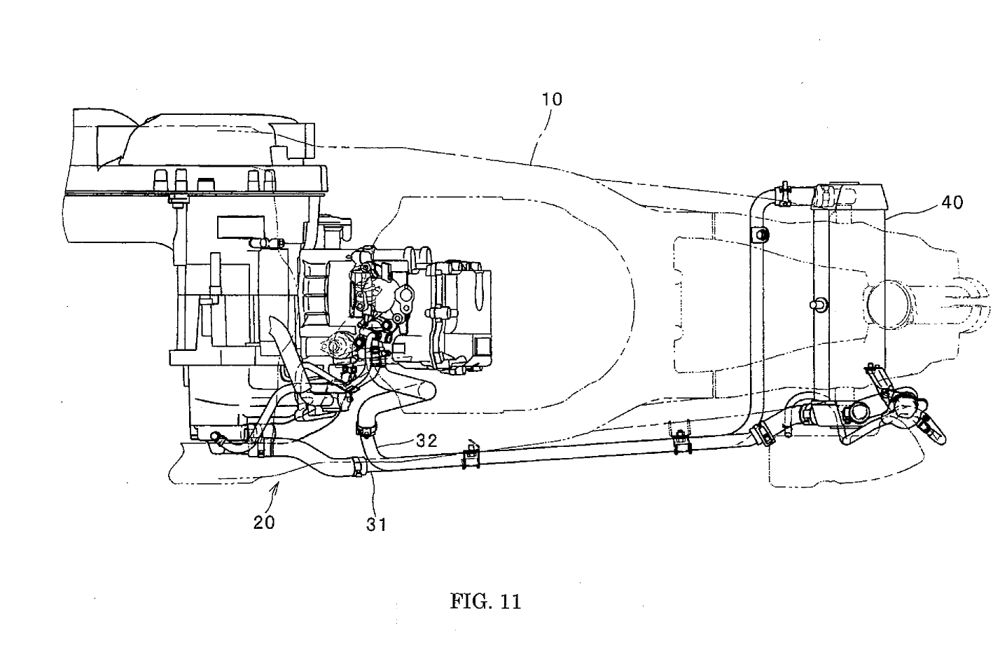

A straddle-type vehicle according to the present invention is not limited to motorcycle 1 of FIG. 1 or scooter 2 of FIG. 11 in a narrow sense, and may be a moped, an off-road vehicle or the like, or a straddle-type vehicle other than a motorcycle such as an ATV (all terrain vehicle) or a snowmobile. A “straddle-type vehicle” as used herein is a vehicle that a rider rides by straddling a seat (a saddle) and includes, for example, a motorcycle, an ATV and a snowmobile. A “motorcycle” as used herein is intended in a broad sense and includes not only a motorcycle in a narrow sense but also a moped, an off-road vehicle, a scooter and the like. A motorcycle also includes a vehicle having a front wheel and a rear wheel, at least one of which is constituted by a plurality of wheels, and is tilted to change a traveling direction. In the following description, the front-back and left-right directions are from the perspective of a rider sitting upright on seat 9.

### First Embodiment

(Schematic Configuration of Motorcycle 1)

FIG. 1 is a left side view of the motorcycle 1 according to a first embodiment of the present invention. As shown in FIG. 1, the motorcycle 1 includes a body frame 10. The body frame 10 includes a head pipe 11 and a main frame 12. The head pipe 11 is arranged in a front portion of motorcycle 1. The main frame 12 extends from the head pipe 11 obliquely rearward and downward.

A steering shaft is rotatably inserted into the head pipe 11. A handle 13 and a pair of front forks 14 are connected to the steering shaft. A front wheel 15 is rotatably attached to lower end portions of the paired front forks 14. A pivot shaft 16 is attached to a rear portion of the main frame 12. A rear arm 17 is pivotally attached to the pivot shaft 16. A rear wheel 18 is rotatably attached to a rear end portion of the rear arm 17.

An engine 20 serving as a power source is suspended on the main frame 12. A cross-flow-type radiator 40 is arranged in front of the engine 20. A cooling liquid flows in the radiator 40 in a vehicle width direction, that is, obliquely upward or downward from one side to the other side in the vehicle width direction. In this description, a “cross-flow-type radiator” is not limited to a radiator in which cooling liquid flows toward the vehicle width direction, and include whole radiators in which cooling liquid flows from one side to the other side in the vehicle width direction. It is to be noted, however, that a so-called turn-flow-type radiator in which cooling liquid flows from one side to the other side in the vehicle width direction and then flows back to the other side in the vehicle width direction is not a “cross-flow-type radiator”.

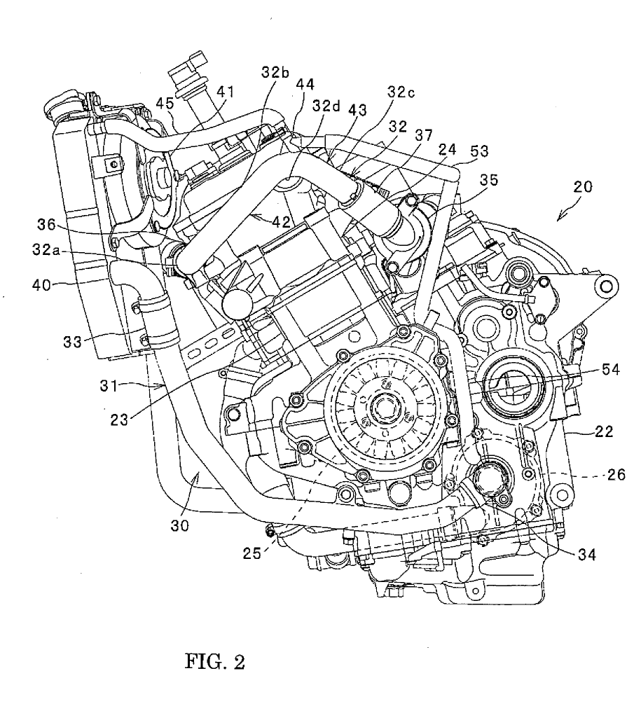

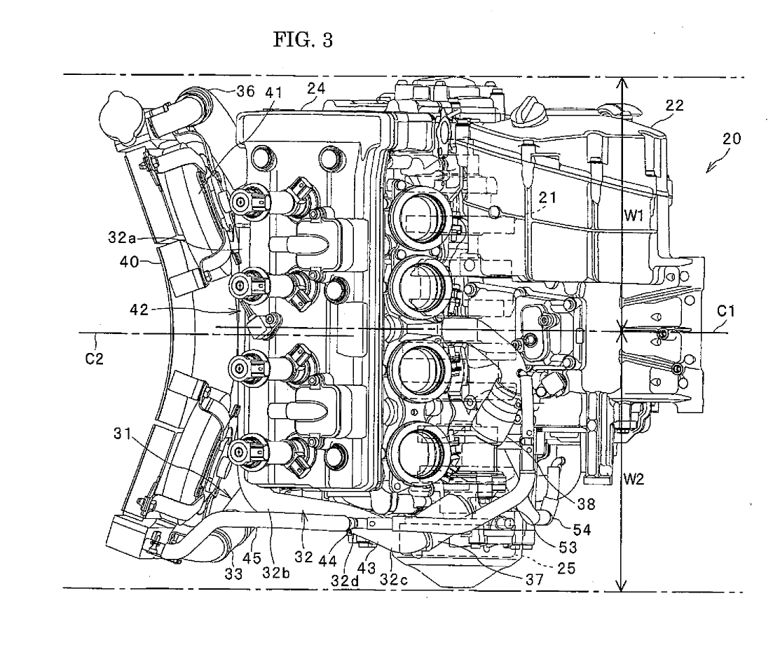

As shown in FIGS. 2 and 3, a radiator fan 41 is arranged on a rear surface of the radiator 40 in order to improve the cooling liquid cooling efficiency of the radiator 40 when, for example, the motorcycle 1 halts or has a low speed. While water is used as the cooling liquid in this embodiment, the cooling liquid is not limited to water. The cooling liquid may be, for example, a mixture of water and a liquid other than water, such as a mixture of water and antifreeze. Furthermore, the cooling liquid may be a liquid in which one or a plurality of solutes is dissolved in one or a plurality of solvents.

In the present embodiment, the engine 20 is a water-cooled transverse four-cylinder engine. However, the type of the engine is not limited to a specific type as long as the engine is cooled using cooling liquid. The engine may be, for example, a transverse two-cylinder engine, a transverse three-cylinder engine or a transverse five or more-cylinder engine. Furthermore, the engine may be a single-cylinder engine, an in-line multiple-cylinder engine, a horizontally-opposed multiple-cylinder engine or a V-type multiple-cylinder engine.

An exhaust pipe 27 is connected to the engine 20. An exhaust muffler 28 is connected to a distal end portion of the exhaust pipe 27. Exhaust gas purifying catalyst 29 is arranged within the exhaust pipe 27. Exhaust gas from the engine 20 is emitted into the external air via the exhaust pipe 27 and the exhaust muffler 28. The exhaust gas is purified by the exhaust gas purifying catalyst 29 arranged within the exhaust pipe 27. Specifically, concentrations of carbon monoxide and NOx in the exhaust gas are reduced.

The exhaust gas purifying catalyst 29 is not limited to a specific type and may be a conventionally and normally used catalyst. Generally, an exhaust gas purifying catalyst exhibits low catalytic activity at a normal temperature. Therefore, when the motorcycle 1 starts, the exhaust gas purifying catalyst 29 exhibits low catalytic activity. In a state in which the engine 20 is warmed up and the temperature of the exhaust gas purifying catalyst 29 rises, the exhaust gas purifying catalyst 29 exhibits high catalytic activity.

(Schematic Structure of Engine 20)

Referring mainly to FIGS. 2 and 3, the engine 20 will be described in detail. As shown in FIG. 3, the engine 20 includes a crankshaft 21 that extends in the vehicle width direction and is accommodated in a crankcase 22. As shown in FIG. 2, a body cylinder 23 is attached to a first half part of the crankcase 22. A head cylinder 24 is attached to an upper portion of the body cylinder 23. Four cylinders are formed in parallel in the body cylinder 23. A piston is slidably and displaceably arranged in each of the cylinders. Each piston is connected to the crankshaft 21.

As shown in FIG. 3, a generator 25 is arranged in a left end portion of the crankshaft 21. Rotation of the crankshaft 21 is transmitted to the generator 25 to drive the generator 25. As shown in FIG. 2, a water pump 26 is arranged in the crankcase 22 obliquely downward of the generator 25.

(Arrangement of Engine 20)

As shown in FIG. 3, a center axis C1 of the engine 20 is rightward of a center axis C2 of the motorcycle 1 in the vehicle width direction. That is, in the present embodiment, the engine 20 is offset rightward in the vehicle width direction.

Where the number of cylinders arranged in the vehicle width direction is 2n (n is a natural number), the “center axis of the engine in the vehicle width direction” passes a center between a center axis of an nth cylinder and a center axis of an (n+1)^{th} cylinder from one side in the vehicle width direction, and extends in the front-back direction. For example, in the present embodiment, as the engine 20 is a transverse four-cylinder engine, the center axis C1 passes a center between a center axis of the second cylinder from the right and the third cylinder from the right in the vehicle width direction, and extends in the front-back direction. Further, where the number of cylinders arranged in the vehicle width direction is 2m+1 (m is an integer equal to or greater than 0), the “center axis of the engine in the vehicle width direction” passes a center axis of an (m+1)^{th} cylinder from the right in the vehicle width direction, and extends in the front-back direction. Specifically, in the case of a single-cylinder engine, the center axis of the engine in the vehicle width direction passes a center axis of a cylinder and extends in the front-back direction. In the case of a three-cylinder engine, the center axis of the engine in the vehicle width direction passes a center axis of a cylinder located at a center, and extends in the front-back direction.

Moreover, the “center axis of the straddle-type vehicle in the vehicle width direction” passes a center axis of the head pipe and extends in the front-back direction in a plan view. The center axis C2 in the present embodiment passes a center axis of the head pipe 11 (FIG. 1) and extends in the front-back direction.

As shown in FIG. 3, because the generator 25 is arranged in the left end portion of the crankshaft 21, a distance W2 from the center axis C1 of the engine 20 to a left end portion of the engine 20 is longer than a distance W1 from the center axis C1 of the engine 20 to a right end portion of the engine 20.

As shown in FIG. 3, a center axis of the radiator 40 is substantially identical in position to the center axis C1 of the motorcycle 1 in the vehicle width direction. That is, the radiator 40 is substantially not offset in the vehicle width direction.

A right end of the engine 20 is substantially flush with a right end of the radiator 40 in the vehicle width direction, and a left end of the engine 20 is substantially flush with a left end of the radiator 40. More specifically, both ends of the radiator 40 are located slightly inward of those of the engine 20 in the vehicle width direction.

(Connection of Radiator 40 to Engine 20)

As shown in FIGS. 2, 3 and 6, the engine 20 is connected to the radiator 40 by a first piping 31 and a second piping 32. The first piping 31 is connected to the left end portion of the radiator slightly below a central portion of the radiator 40 in a height direction. As shown in FIG. 2, the first piping 31 is connected to a lower portion of a second half part of the crankcase 22.

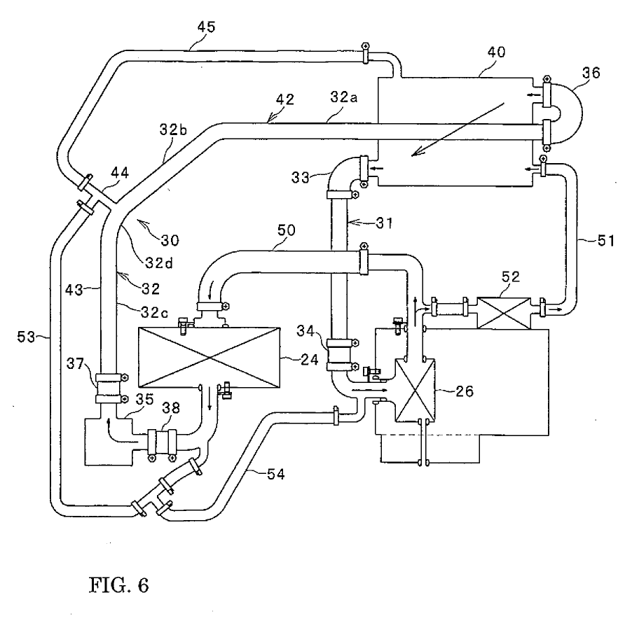

As shown in FIG. 3, the second piping 32 is connected to the right, upper end portion of the radiator 40. As shown in FIGS. 2 and 6, the second piping 32 is connected to the head cylinder 24 via a thermostat 35.

As shown in FIG. 6, cooling water cooled in the radiator 40 is transferred to the engine 20 via the first piping 31 and circulates in the engine 20. The cooling water circulating in the engine 20 is transferred to the radiator 40 via the second piping 32. In this way, the first piping 31, the second piping 32, the radiator 40 and the engine 20 form a circulating circuit 30 through which cooling liquid circulates.

The first piping 31 and the second piping 32 may be directly connected, respectively, to the engine 20 and the radiator 40. Alternatively, the first piping 31 and the second piping 32 may be connected to the engine 20 and the radiator 40 by joints, for example. Specifically, in the present embodiment as shown in FIGS. 2 and 6, the first piping 31 is connected to the radiator 40 by a joint 33 and to the crankcase 22 by a joint 34. As shown in FIGS. 3 and 6, the second piping 32 is connected to the radiator 40 by a joint 36 and to the head cylinder 24 by a joint 37, the thermostat 35 and a joint 38. Thermostat 35 is not shown in FIG. 3 for convenience of description.

In the present embodiment, at least one of the first piping 31 and the second piping 32 is substantially constituted by resin piping. Specifically, a longer of the first piping 31 and the second piping 32, that is, the second piping 32 is substantially constituted by resin piping. More specifically, both the first piping 31 and the second piping 32 are constituted by resin piping formed integrally.

The first piping 31 and the second piping 32 may be formed integrally or by connecting a plurality of pipings. For example, the first piping 31 and the second piping 32 may be formed by connecting a plurality of resin pipings by resin, rubber or metal joints. In the present embodiment, the “piping is substantially constituted by the resin piping” encompasses piping that is formed by a plurality of resin pipings connected by non-resin joints.

As shown in FIG. 2, the first piping 31 extends obliquely rearward from the left end portion of the radiator 40 and downward toward the left of the engine 20. The first piping 31 is connected to the lower portion of the second half part of the crankcase 22 via below the generator 25.

As shown in FIG. 3, the second piping 32 extends from the right end portion of the radiator 40 substantially horizontally toward the left of the engine 20, between the radiator 40 and the engine 20, in the front-back direction. The second piping 32 is bent rearward at the diagonally forward left of the engine 20. As shown in FIGS. 2 and 3, the second piping 32 extends rearward at the left of the engine 20.

As shown in FIG. 2, the second piping 32 includes a first piping section 32a, a second piping section 32b and a third piping section 32c. The first piping section 32a and the second piping section 32b constitute a radiator-side piping section 42. The third piping section 32c constitutes an engine-side piping section 43.

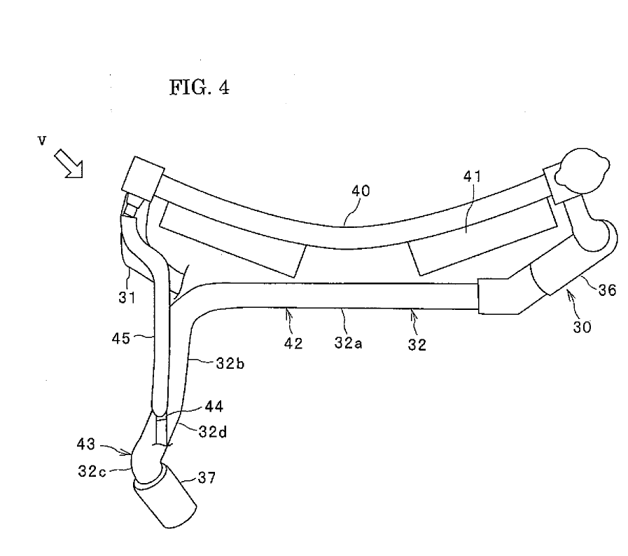

As shown in FIG. 4, the first piping section 32a is connected to the joint 36. The first piping section 32a extends substantially horizontally to the vehicle width direction. The left end portion of the first piping section 32a is connected to the second piping section 32b.

As shown in FIG. 2, the second piping section 32b extends from a connection section, in which the second piping section 32b is connected to the first piping section 32a, substantially linearly obliquely upward and rearward at the left of the engine 20. The radiator-side piping section 42 is thereby becomes higher from the radiator 40 side to the engine 20 side.

A rear end portion of the second piping section 32b is connected to the third piping section 32c serving as the engine-side piping section 43. A rear end portion of the third piping section 32c is connected to a joint 37. The third piping section 32c extends obliquely downward to rearward at the left of the engine 20. A connection section 32d in which the third piping section 32c is connected to the second piping section 32b is thereby located at the highest position of the second piping 32.

In this way, connection section 32d in which the second piping section 32b is connected to the third piping section 32c is located at the highest position of the second piping 32. A bleeder piping 45 is connected to connection section 32d via a joint 44. As shown in FIGS. 2 and 3, a front end portion of the bleeder piping 45 is connected to the left end portion of the upper end portion of the radiator 40.

(Cooling Water Circulating Circuit 30)

Referring mainly to FIG. 6, a configuration of the circulating circuit 30 through which cooling water circulates is described in more detail. A main circuit of the circulating circuit 30 includes the water pump 26, a circulation path 50, the head cylinder 24, the second piping 32, the radiator 40 and the first piping 31, all of which are arranged in the engine 20.

The circulation path 50 connects the water pump 26 to the head cylinder 24. Cooling water pressured by the water pump 26 is transferred to a water jacket formed in the head cylinder 24 via circulation path 50 and cools the head cylinder 24. The circulation path 50 may be formed either within the engine 20 or by piping arranged outside of the engine 20.

Cooling water from the head cylinder 24 is transferred to the radiator 40 via the thermostat 35 and the second piping 32. The cooling water is cooled in the radiator 40. Cooling water from the radiator 40 is returned again to the water pump 26 via the first piping 31.

The water pump 26 and the radiator 40 are also connected to each other by a circulation path 51. An oil cooler 52 is arranged on the circulation path 51 and is supplied with cooling water. Therefore, the oil cooler 52 cools lubricating oil supplied to a slide section or the like of the engine 20.

Circulating circuit 30 includes a circulation path 53 connecting the head cylinder 24 to the joint 44 and a circulation path 54 connecting the head cylinder 24 to the water pump 26. If the thermostat 35 is closed, cooling water from the head cylinder 24 flows into the second piping 32 through the joint 44 via circulation path 53.

The joint 44 and the radiator 40 are connected to the radiator 40 by the bleeder piping 45. Air in the second piping 32 is emitted from the second piping 32 via bleeder piping 45.

As stated above, iron piping is conventionally and mainly used to connect the engine to the radiator. In a state in which the engine is sufficiently warmed up, the temperature of the cooling liquid is relatively high. Generally, it is desirable to efficiently cool this high-temperature cooling liquid by a small radiator and to improve cooling efficiency of the entire cooling liquid circulating circuit including the radiator. The piping connecting the engine to the radiator is thus normally metal piping having high heat conductivity.

If the piping connecting the engine to the radiator is resin piping, the radiation amount from the cooling liquid in the piping is small and the cooling efficiency for cooling the cooling liquid tends to be deteriorated. Considering the cooling efficiency for cooling the cooling liquid, therefore, it is not always preferable to use resin piping to connect the engine to the radiator.

Nevertheless, if iron piping is used to connect the engine to the radiator, cooling liquid warmed by the engine is cooled by the piping connecting the engine to the radiator during warming up of the engine. Due to this, the time required to warm up the engine tends to be long. As stated above, the exhaust gas purifying catalyst 29 exhibits low catalytic activity in a low temperature state. Thus, the catalytic activity of the exhaust gas purifying catalyst 29 is relatively low during warming up of the engine, and it is difficult to reduce emission of exhaust gas that is lower in degree of purification than exhaust gas emitted when the engine is warmed up. Accordingly, it tends to be difficult to comply with recent stricter emission controls.

In this embodiment, by contrast, at least one of the first piping 31 and the second piping 32 is constituted by resin piping. During warming up of the engine 20, reduction in temperature of cooling liquid in the first piping 31 and the second piping 32 is thereby suppressed, and engine 20 can be warmed up relatively quickly. Accordingly, emission of exhaust gas before the engine 20 is warmed up that is lower in degree of purification than exhaust gas emitted when the engine 20 is warmed up is effectively reduced, thereby facilitating compliance with recent stricter emission controls.

In the present embodiment, at least the longer of the first piping 31 and the second piping 32 is constituted by resin piping. Reduction in the temperature of cooling liquid in the first piping 31 and the second piping 32 is thereby suppressed.

In the present embodiment, both the first piping 31 and the second piping 32 may be constituted by resin piping. Reduction in the temperature of cooling liquid in the first piping 31 and the second piping 32 is thereby particularly effectively suppressed.

Moreover, in the present embodiment, the radiator 40 is a cross-flow-type radiator. Cooling efficiency for cooling cooling liquid is thereby high in the radiator 40, and high cooling efficiency for cooling cooling liquid after the engine 20 is sufficiently warmed up is thereby attained.

(Method of Manufacturing Resin Piping)

In the present embodiment, the method of manufacturing the resin piping is not limited to a specific method. The resin piping can be manufactured by, for example, a so-called RFM (RP TOPLA Floating core Molding) formation method such as that disclosed in Japanese Patent No. 3771295 or the like.

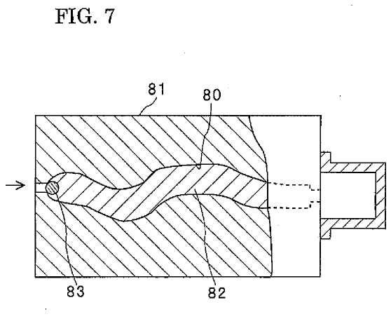

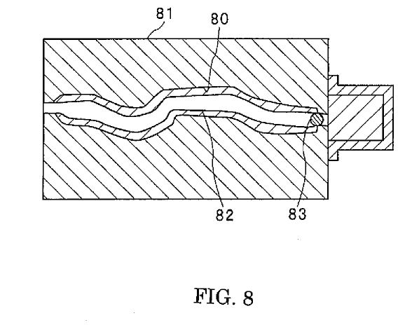

If the resin piping is to be manufactured by the RFM formation method, as shown in FIG. 7, a forming die 81 in which a formation space 80 substantially identical in external shape to the resin piping to be manufactured is prepared. While the forming die 81 is kept at a predetermined temperature, molten resin 82 is filled up in the formation space 80. As shown in FIG. 8, by applying gas pressure from a proximal end side of the formation space 80, a floating core 83 substantially identical in inside diameter to the resin piping to be manufactured is moved from the proximal end side to a distal end side of the formation space 80, whereby resin piping substantially uniform in thickness is manufactured.

### Modification of First Embodiment

In the first embodiment, an instance in which both the first piping 31 and the second piping 32 are constituted by resin piping has been described. However, one of the first piping 31 and the second piping 32 may not necessarily be resin piping. For example, a part of or a front portion of the relatively short first piping 31 may be made of metal.

### Second Embodiment

One embodiment for carrying out the present invention has been described with the motorcycle 1 as an example. However, a straddle-type vehicle according to the present invention is not limited to the motorcycle 1 and may be, for example, a scooter 2 as shown in FIG. 9. In describing this second embodiment, members having substantially the same functions as those of the first embodiment are denoted by common reference symbols, and are not described.

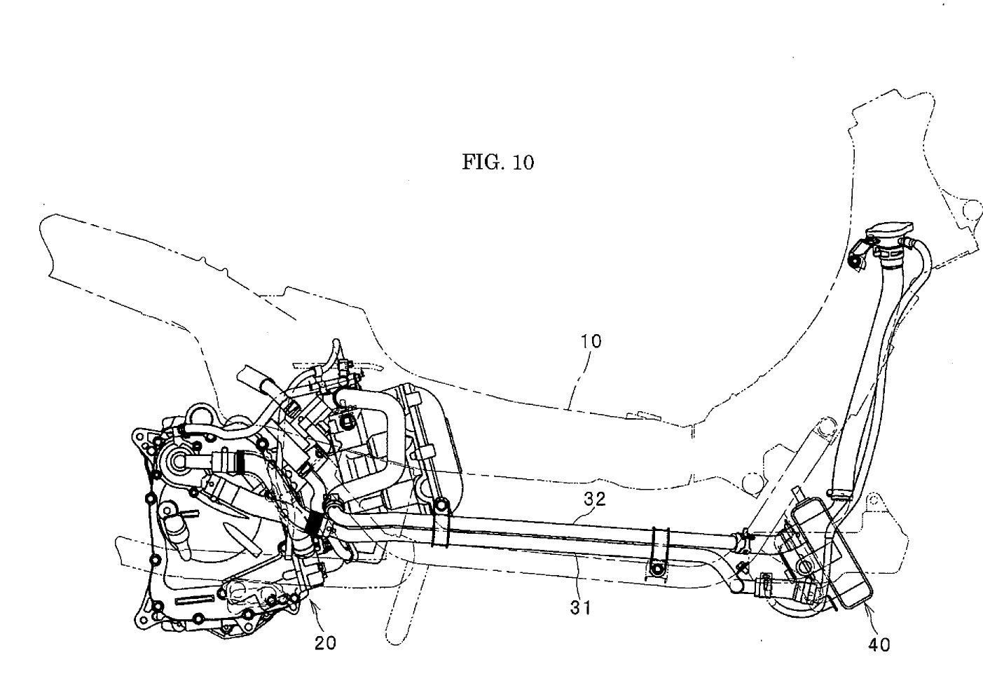

In the second embodiment, as shown in FIGS. 10 and 11, an engine 20 is pivotally attached to a second half part of a body frame 10. The engine 20 is rearward of a front end of a seat 9.

A concave portion 61 concaved downward is formed between a front panel 60 and the seat 9. A tunnel section 62 protruding upward is formed in the concave portion 61. Footsteps 63 are arranged on both sides of the tunnel section 62 in a vehicle width direction.

As shown in FIGS. 10 and 11, a radiator 40 is attached to a first half part of the body frame 10 and is arranged just behind front wheel 15. As shown in FIG. 9, the radiator 40 is arranged forward of the footsteps 63. The radiator 40 is opposed to the engine 20 in the first embodiment, whereas it is not opposed to the engine 20 in the second embodiment.

As shown in FIGS. 10 and 11, the engine 20 and the radiator 40 are arranged at positions relatively apart from each other in the scooter 2. Due to this, first piping 31 and second piping 32 are arranged to extend in a front-back direction downward of the footsteps 63 in the second embodiment. Therefore, the first piping 31 and the second piping 32 are longer and the advantage obtained by constituting at least one of the first piping 31 and the second piping 32 by resin piping is greater.

1. A straddle-type vehicle comprising:
an engine;
a radiator that cools a cooling liquid;
a first piping that connects the engine to the radiator; and
a second piping that connects the engine to the radiator and that, together with the engine, the radiator, and the first piping, forms a circulating circuit through which the cooling liquid circulates;
wherein at least one of the first piping and the second piping is substantially constituted by resin piping.

2. The straddle-type vehicle according to claim 1, wherein a longer of the first piping and the second piping is substantially constituted by resin piping.

3. The straddle-type vehicle according to claim 1, wherein both the first piping and the second piping are substantially constituted by resin piping.

4. The straddle-type vehicle according to claim 1, further comprising:
a joint that connects the piping substantially constituted by resin piping to the engine or the radiator.

5. The straddle-type vehicle according to claim 1, wherein
the radiator is arranged in front of the engine,
the first piping is connected to one end portion of the radiator in a vehicle width direction, and
the second piping is connected to an other end portion of the radiator in the vehicle width direction, extends toward one side of the engine in the vehicle width direction, and is substantially constituted by resin piping.

6. The straddle-type vehicle according to claim 1, comprising:
a body frame having a first half part to which a radiator is attached, and a second half part to which the engine is pivotally attached; and
a seat attached to the body frame.
